(19) United States
(12) Patent Application Publication
(10) Pub. No.: US 2024/0427986 A1
(43) Pub. Date: Dec. 26, 2024

(54) LARGE LANGUAGE MODEL SCREENING SYSTEM AND METHODS THEREOF

(71) Applicants: Paulo Shakarian, Chandler, AZ (US); Noel Ngu, Tempe, AZ (US); Lakshmivihari Mareedu, Tempe, AZ (US); Abhinav Koyyalamudi, Tempe, AZ (US)

(72) Inventors: Paulo Shakarian, Chandler, AZ (US); Noel Ngu, Tempe, AZ (US); Lakshmivihari Mareedu, Tempe, AZ (US); Abhinav Koyyalamudi, Tempe, AZ (US)

(73) Assignee: Arizona Board of Regents on Behalf of Arizona State University, Tempe, AZ (US)

(21) Appl. No.: 18/748,899

(22) Filed: Jun. 20, 2024

Related U.S. Application Data
(60) Provisional application No. 63/509,237, filed on Jun. 20, 2023.

(51) Int. Cl. G06F 40/20

(52) U.S. Cl. CPC G06F 40/20

(57) ABSTRACT

Disclosed are examples of a computer implemented screening system for large language models (LLMs). The disclosed examples are designed to address technical issues and other concerns associated with LLMs by conducting automatic screening on the input and output of these models. In some variations, the described technology is directed to a system for analyzing the accuracy of large language models (e.g., ChatGPT) in performing textual math word problems. Users input word math problems into the LLM, the output is then analyzed by the proposed technique and the user is given a score of how accurate the LLM response is.

### CROSS REFERENCE TO RELATED APPLICATIONS

This is a non-provisional application that claims benefit to U.S. Provisional Application Ser. No. 63/509,237, filed on Jun. 20, 2023, which is herein incorporated by reference in its entirety.

### FIELD

The present disclosure generally relates to artificial intelligence systems including large language models; and in particular to a large language model screening system and methods thereof.

### BACKGROUND

Large language models (LLMs) such as ChatGPT, GPT-3, and others have shown much promise for solving various problems. However, inaccuracies in results, the ability to produce false information, and the ability to produce offensive outputs have been previously noted. It is with these observations in mind, among others, that various aspects of the present disclosure were conceived and developed.

### BRIEF DESCRIPTION OF THE DRAWINGS

FIG. 1A is a simplified illustration of an example system for LLM screening as described herein.

FIG. 1B is a simplified illustration of various modules and/or components of the example LLM screening systems from FIG. 1A and as described herein.

FIG. 1C is an example illustration of ChatGPT's response (Jan. 24, 2023) to MWP One whole number is three times a second. If 20 is added to the smaller number, the result is 6 more than the larger. In Step A it correctly identifies the set of equations needed to solve the problem and correctly simplifies it in Step B. However, it fails to correctly perform the algebraic operation in Step C (it should state 2y=14). This leads ChatGPT to obtain an incorrect result, returning 42 and 14 instead of 21 and 7.

FIG. 2 is a set of pie charts illustrating overall results on the 1,000 MWPs in DRAW-1K based on ChatGPT's response.

FIG. 3 is a series of graphs illustrating aspects of MWPs that led to ChatGPT failure more often than the prior (95% confidence intervals shown).

FIG. 4 is a graph illustrating additional finding specific to the February 2023 experiment where ChatGPT displayed its work relating number of multiplications to probability of failure, R²=0 . . . 802, 95% confidence intervals.

FIG. 5 is a series of graphs illustrating increase in probability of an incorrect response as a function of the number of addition operations (prior probability shown with dashed line, 95% confidence intervals, linear regression with R²=0.821 for January, R²=0.870 for February without showing work and R²=0.915 for February with showing work).

FIG. 6 is a simplified illustration of an example computing device that can be implemented by the system to perform various functions, operations, or other features described herein.

Corresponding reference characters indicate corresponding elements among the view of the drawings. The headings used in the figures do not limit the scope of the claims.

### DETAILED DESCRIPTION

The present disclosure relates to examples of a computer implemented screening system for large language models (LLMs). This concept—the “Large Language Model Screening System” is designed to address technical issues and other concerns associated with LLMs by conducting automatic screening on the input and output of these models. In some examples, the described technology is directed to a system for analyzing the accuracy of large language models (e.g., ChatGPT) in performing textual math word problems. Users input word math problems into the LLM, the output is then analyzed by the proposed technique and the user is given a score of how accurate the LLM response is.

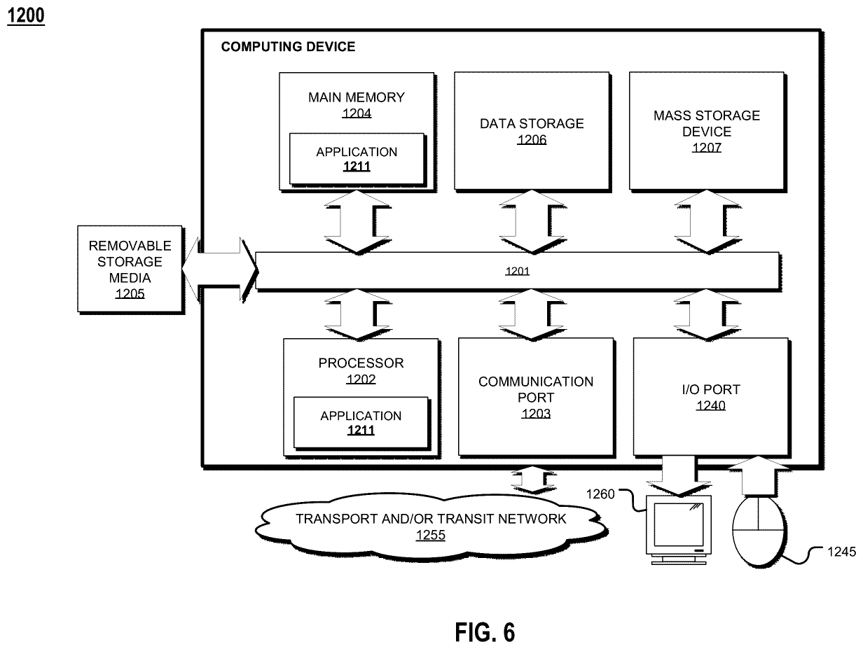

A Note on LLMs. LLM's can be created within an organization and used directly, or an organization can use an LLM provided by a third party (e.g., OpenAI, Google, Meta, etc.). The present disclosure describes examples of an LLM Screening System to be agnostic to the underlying LLM, who owns it, or where it resides. Examples can process input before going to one or more LLM's and process the output of the LLM's before providing it to the user. Example, functions/logic, systems and/or architectures described herein can include modules/components implemented as code, software, and/or machine-executable instructions executable by a processor that may represent one or more of a procedure, a function, a subprogram, a program, a routine, a subroutine, a module, an object, a software package, a class, or any combination of instructions, data structures, or program statements, and the like. In other words, one or more of the features for processing described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103 and/or the memory of computing device 1200 of FIG. 6), and the processor performs the tasks defined by the code.

While it is reasonable to assume that an example of this architecture would interface with an LLM via API, that would be just one embodiment. An alternative approach could be for this system to interface with the LLM in a different manner (e.g., have input or output processed by another program prior to going to the LLM, have the LLM Screening System be tightly coupled with the LLM itself, etc.). Likewise, similar considerations can be used to take into account the input from the user. Further, there is no requirement to assume a single LLM-multiple could be used. This would further allow the LLM Screening System to screen results to/from particular LLMs and even rank results of LLMs before presenting them to the user.

Software components can also be embodied in many different ways. For example, the screening system can be implemented as part of an app, website, or desktop software used for interfacing with an LLM—and the processing can take place all or in-part on a client system. It is also contemplated and within the scope of the present disclosure that the subject LLM Screening System can be implemented in a manner similar to that of a firewall used in cybersecurity. The system can be used in a form of middleware running on the same system as the LLM. It can also be implemented in the form of a software library and fully integrated with LLM software. In the latter case, one can envision the LLM Screening System being used during the training process as well (e.g., integrated with the forward pass). Other such implementations and examples are contemplated.

### Example Key Concepts.

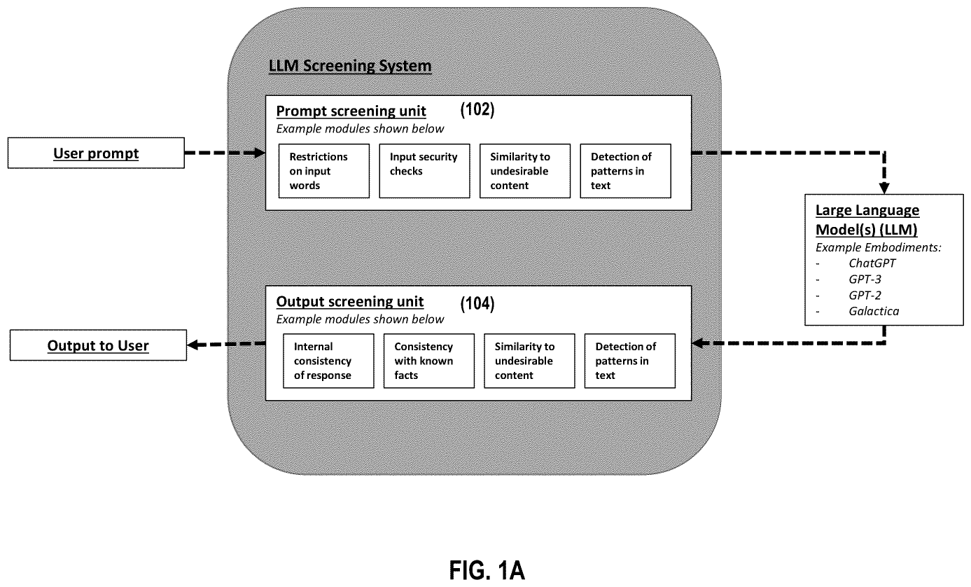

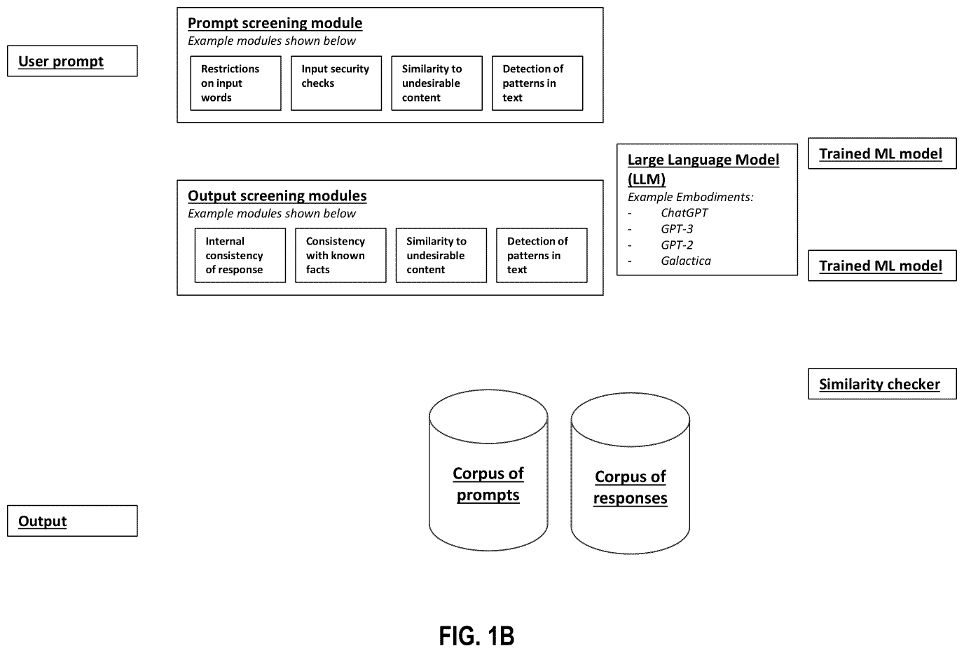

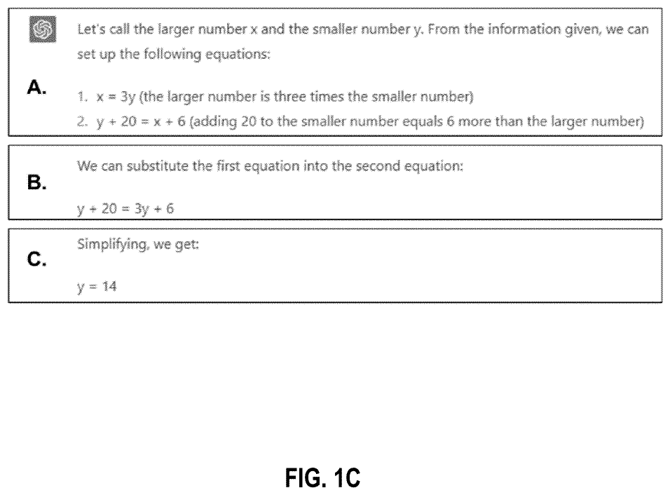

Referring to FIG. 1A, of LLM Screening Systems can include two main components:

Prompt screening unit (102). This module pre-processes the user input before sending it to the LLM. The idea is that the user input may position the LLM to produce false, misleading, or offensive output. We envision this unit to be implemented in software that provides for a general interface between the prompt and one or more LLM's on the backend. If the prompt is blocked, it does not proceed to the LLM. The user is either returned an error message or no response. This unit is comprised of one or more modules that perform various types of checks. We provide some examples below.
a. Input restrictions module. This module would simply check if certain key words or phrases exist in the prompt.
b. Input security checks. This module would check for security information (e.g., personally identifiable numbers, mother's maiden name, etc.)
c. Similarity to undesirable content. This module would consider a corpus prompts deemed not suitable for use (e.g., have been used to elicit improper responses from the LLM) and conducts a similarity comparison (e.g., using a distance function or a neural network) to the collected content
d. Model based classification of prompt. This module would use a machine learning model trained on textual data associated with undesirable prompts. The classifier could also be trained to classify based on the reason the text is undesirable as well.
e. Indicator based input module. This module would extract potential indicators from text and use combinations of these indicators (either specified by an expert or learned from data) that would be disallowed. Example indicators would include analysis of parts of speech, combinations of certain topics (based on natural language pre-processing), or (for computer code) based on structural aspects of the code.
f. Detection of patterns within the text. This module would be designed to find patterns in the text that deviate from “white listed” prompts or are manually specified (a priori). Such patterns could be based on indicators (e.g., module “e” above), machine learning results, or statistical analysis
g. Variation of the above, but consider sequences of prompts. Many LLM's (e.g., ChatGPT) are conversational, in that they process sequences of prompts. Hence, it could be the case that a single prompt, by itself, may not need to be screened, but a prompt in the context of the larger discussion may fit a pattern, be tagged by a model, maybe the concatenation of prompts may be similar to a disallowed prompt. Hence, variants of the modules that consider sequences of prompts is another important example of a module.

Output screening module (104). This module processes the output of the LLM before the user receives it. The LLM may produce false, misleading, or offensive output even when operation on screened prompts. We envision this unit to be implemented in software that provides for a general interface between LLM output and how the user receives the final result (e.g., API, user interface, etc.). If the output is blocked, it does not proceed to the user. The user is either returned an error message or no response. This unit is comprised of one or more modules that perform various types of checks. We provide some examples below.
a. Internal consistency of response. An answer provided to a prompt that itself hold contradictions is likely an invalid answer. There are two ways to check internal consistency. First is to convert language output into logic and detect inconsistencies. However, such a procedure would only be a rough approximation based on current technology. A second method, for use with either multiple LLM's or LLM's that provide stochastic responses is to compare the various responses and identify variations among them, identifying for diversity or inconsistency among responses.
b. Consistency with known facts. There are various repositories of formatted knowledge such as Wikidata that can also be compared with a prompt response through various means.

The inventive concepts described for LLM screening can be applied to one or more LLMs, examples provided below.

### Independent Evaluation of ChatGPT on Mathematical Word Problems (MWP)

### 1. Introduction (Chat GPT Example)

The emergence of large language models (LLM) has gained much popularity in recent years. At the time of this writing, some consider OpenAI's GPT 3.5 series models as the state-of-the art. In particular, a variant tuned for natural dialogue known as ChatGPT, released in November 2022 by OpenAI, has gathered much popular interest, gaining over one million users in a single week. However, in terms of accuracy, LLMs are known to have performance issues, specifically when reasoning tasks are involved. This issue, combined with the ubiquity of such models has led to work on prompt generation and other aspects of the input. Other areas of machine learning, such as meta-learning and introspection attempt to predict when a model will succeed or fail for a given input. An introspective tool, especially for certain tasks, could serve as a front-end to an LLM in a given application.

As a step toward such a tool, we investigate aspects of math word problems (MWPs) that can indicate the success or failure of ChatGPT on such problems. We found that ChatGPT's performance changes dramatically based on the requirement to show its work, failing 20% of the time when it provides work compared with 84% when it does not. Further several factors about MWPs can lead to a higher probability of failure when compared with the prior, specifically noting that the probability of failure increases linearly with the number of addition and subtraction operations (across all experiments). We also have released the dataset of ChatGPT's responses to the MWPs to support further work on the characterization of LLM performance. While there has been previous work examining the LLM performance on MWPs, such work did not investigate specific aspects that increase MWP difficulty nor did it examine performance on ChatGPT in particular.

The remainder of this paper proceeds as follows. In Section 2, we describe our methodology. Then we describe our results in Section 3. Using these intuitions, we present baseline models to predict the performance of ChatGPT in Section 4. This is followed by a discussion of related work (Section 5) and future work (Section 6).

### 2. Methodology

MWP Dataset. In our study, we employed the DRAW-1K dataset which not only includes 1,000 MWPs with associated answers but also template algebraic equations that one would use to solve such a word problem. As a running example, consider the following MWP.
One whole number is three times a second. If 20 is added to the smaller number, the result is 6 more than the larger.

We show ChatGPT's (incorrect) response to this MWP in FIG. 1C. The DRAW-1K dataset not only includes the correct answer, which in this case is 12 and 7 but also includes template equations used to solve the problem. For our running example, this consists of the equations m−n=a−b and c×m−n=0. This information represents a symbolic representation of the problem which can potentially be used to identify aspects that make such problems more difficult.

Entering Problems into ChatGPT at Scale. At the time of our study, OpenAI, the maker of ChatGPT had not released an API. However, using the ChatGPT CLI Python Wrapper we interfaced with ChatGPT allowing us to enter the MWP's at scale. For the first two experiments, we would add additional phrases to force ChatGPT to show only the final answer. We developed these additions to the prompt based on queries to ChatGPT to generate the most appropriate phrase. However, we found in our third experiment that this addition impacted results. We ran multiple experiments to test ChatGPT's ability with these problems.
January 2023 Experiment (No work). Our first experiment was run in early January 2023 prior to OpenAI's announcement of improved performance on mathematical tasks on Jan. 30, 2023 and in this experiment we included the following statement as part of the prompt.
Don't provide any work/explanation or any extra text. Just provide the final number of answers for the previous question, with absolutely no other text. if there are two or more answers provide them as a comma separated list of numbers.
February 2023 Experiment (No work). Our second experiment was run in mid-February 2023 after the aforementioned OpenAI announcement and also used a prompt that would cause ChatGPT to show only the answer, however we found that our original prompt led to more erratic behavior, so we modified the prompt for this experiment, and used the following.
Don't provide any work/explanation or any extra text. Just provide the final number of answers for the previous question, with absolutely no other text. if there are two or more answers provide them as a comma separated list of numbers like: ‘10, 3,’ etc.; or if there is only 1 answer provide it like ‘10’. Absolutely no other text just numbers alone. Just give me the numbers (one or more) alone. No full stops, no spaces, no words, no slashes, absolutely nothing extra except the 1 or more numbers you might have gotten as answers.
February 2023 Experiment (Showing Work). We also repeated the February experiment without the additional prompt, thereby allowing ChatGPT to show all its work. We note that in this experiment we used ChatGPT Plus which allowed for faster response. At the time of this writing, ChatGPT Plus is only thought to be an improvement to accessibility and not a different model.

### 3. Results

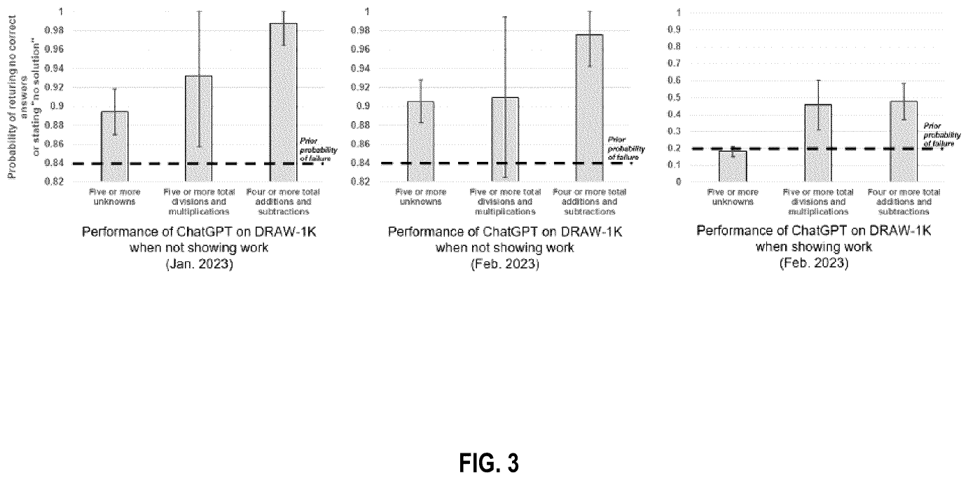

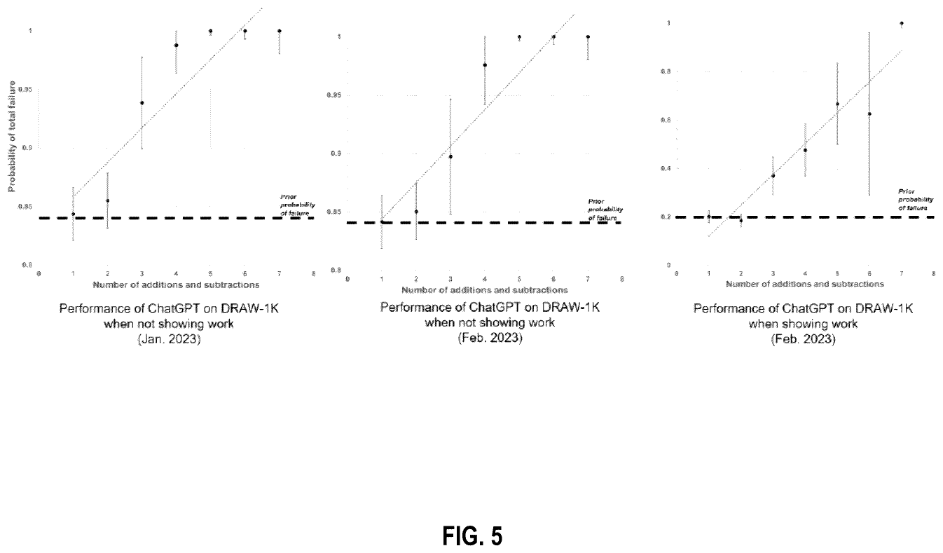

The key results of this paper are as follows: (1.) the creation of a dataset consisting of ChatGPT responses to the MWPs, (2.) identification of ChatGPT failure rates (84% for January and February experiments with no work and 20% for the February experiment with work), (3.) identification of several factors about MWPs relating to the number of unknowns and number of operations that lead to a higher probability of failure when compared with the prior (FIGS. 3 & 4) identification that the probability of failure increases linearly with the number of addition and subtraction operations (FIG. 5) identification of a strong linear relationship between the number of multiplication and division operations and the probability of failure in the case where ChatGPT shows its work.

Dataset. We have released ChatGPT's responses to the 1,000 DRAW-1K MWP's for general use at https://github.com/lab-v2/ChatGPT_MWP_eval. We believe that researchers studying this dataset can work to develop models that can combine variables, operate directly on the symbolic template, or even identify aspects of the template from the problem itself in order to predict LLM performance. We note that at the time of this writing, collecting data at scale from ChatGPT is a barrier to such work as API's are not currently directly accessible, so this dataset can facilitate such ongoing research without the overhead of data collection.

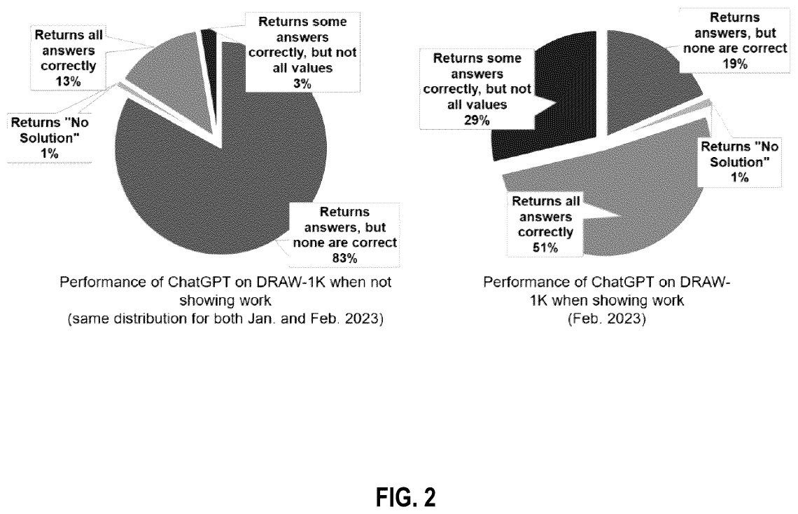

Overall Performance of ChatGPT on DRAW-1K. As DRAW-1K provides precise can complete answers for each problem, we classified ChatGPT responses in several different ways and the percentage of responses in each case is shown in FIG. 2.
1. Returns all answers correctly. Here ChatGPT returned all answers to the MWP (though it may round sometimes).
2. Returns some answer correctly, but not all values. Here the MWP called for more than one value, but Chat GPT only returned some of those values.
3. Returns “No Solution.” Here Chat GPT claims there was no solution to the problem. This was not true for any of the problems.
4. Returns answers, but none are correct. Here ChatGPT returned no correct answers (e.g., see FIG. 1C).

Throughout this paper, we shall refer to the probability of failure as the probability of cases 3 and 4 above (considered together). In our February experiment, we found that when ChatGPT omitted work, the percentages, as reported in FIG. 2 remained the same, though they differed significantly when work was included. We also report actual numbers for all experiments in Table 1. We note that the probability of failure increases significantly when the work is not shown. However, when the work is included, ChatGPT obtains performance in line with state-of-the-art models (i.e., EPT) which has a reported 59% accuracy while ChatGPT (when work is shown) has fully correct (or rounded) answers 51% of the time, but can be viewed as high as 80% if partially correct answers are included.

Factors Leading to Incorrect Responses. We studied various factors from the templated solutions provided for the MWP in the DRAW-1K dataset and these included number of equations, number of unknowns, number of division and multiplication operations, number of addition and subtraction operations, and other variants derived from the metadata in the DRAW-1K dataset. We identified several factors that, when present, cause ChatGPT to fail with a probability greater than the prior (when considering the lower bound of a 95% confidence interval). These results are shown in FIG. 3. One interesting aspect we noticed is that when the system would be required to show its work, the number of unknowns present no longer seems to increase the probability of failure (this was true for all quantities of unknowns in addition to what is shown in FIG. 3). Additionally, the number of multiplication and division operations, while increasing the probability of failure greater than the prior in the January experiment was not significant (based on 95% confidence intervals) in the February experiment (when work was not shown)—possibly a result of OpenAI's improvements made at the end of January. However, there was a significant relationship between the number of multiplication and division operations and failure when work was shown. In fact, we found a strong linear relationship (R²=0.802) for this relationship in the case where work was shown.

TABLE 1
Number of responses for each ChatGPT Variant

| | | | February |
|---|---|---|---|
| | January | February | 2023 |
| | 2023 | 2023 | (Showing |
| Response Type | (No work) | (No work) | Work) |
| Returns answer, but none are correct | 831 | 830 | 186 |
| Returns “No Solution” | 9 | 10 | 14 |
| Returns all answers correctly | 135 | 134 | 513 |
| Returns some answers correctly, but not | 25 | 26 | 287 |
| all values | | | |

Correlation of failure with additions and subtractions. Previous work has remarked on the failure of LLM's in multi-step reasoning. In our study, we identified evidence of this phenomenon. Specifically, we found a strong linear relationship between the number of addition and subtraction operations with the probability of failure (R²=0.821 for the January experiment, R²=0.870 for the February experiment and R²=0.915 when work was shown).

We show this result in FIG. 5. It is noteworthy that the relationship existed in all of our experiments and seemed to be strengthened when ChatGPT included work in the result.

### 4. Performance Prediction Baselines

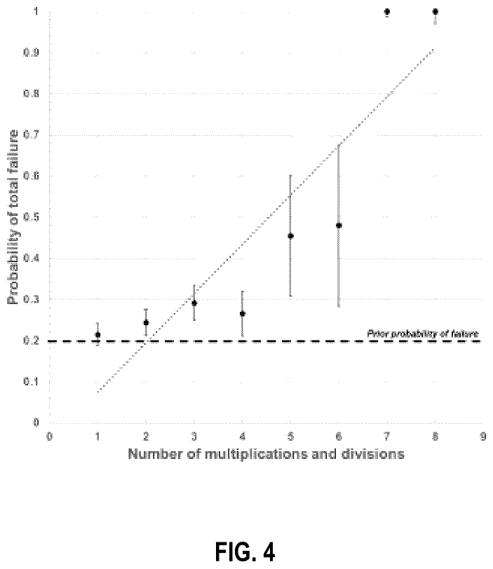

The results of the previous section, in particular, the factors indicating a greater probability of failure (e.g., FIGS. 3-5), may indicate that the performance of ChatGPT can be predicted. In this section, we use features obtained from the equations associated with the MWPs to predict performance. Note that here we use ground-truth equations to derive the features, so the models presented in this section are essentially using an oracle-we leave extracting such features from equations returned by ChatGPT or another tool (e.g., EPT) to future work. That said, as these features deal with counts of operations, unknowns, and equations, a high degree of accuracy in creating the equations would not be required to faithfully generate such features.

Following the ideas of machine learning introspection, we created performance prediction models using random forest and XGBoost. We utilized scikit-learn 1.0.2 and XGBoost 1.6.2 respectively. In our experiments, we evaluated each model on each dataset using a five-fold cross-validation and report average precision and recall in Table 2 (along with F1 computed based on those averages). In general, our models were able to provide higher precision than random on predicting incorrect answers for both classifiers. Further, XGBoost was shown to be able to provide high recall for predicting correct responses. While these results are likely not suitable for practical use, they do demonstrate that the features extracted provide some amount of signal to predict performance and provide a baseline for further study.

TABLE 2
Performance Prediction Baseline Models using Ground Truth Equations

| | Model | Incorr. | Incorr. | Incorr. | Corr. | Corr. | Corr. |
|---|---|---|---|---|---|---|---|
| Version of ChatGPT | Type | Prec. | Recall | FI | Prec. | Recall | FI |
| January (No work) | RF | 0.90 | 0.88 | 0.89 | 0.34 | 0.41 | 0.37 |
| | XGBoost | 0.95 | 0.22 | 0.36 | 0.16 | 0.93 | 0.26 |
| February (No work) | RF | 0.94 | 0.89 | 0.91 | 0.47 | 0.63 | 0.54 |
| | XGBoost | 0.98 | 0.35 | 0.51 | 0.18 | 0.95 | 0.31 |
| February (Showing | RF | 0.78 | 0.69 | 0.73 | 0.74 | 0.82 | 0.78 |
| work) | XGBoost | 0.77 | 0.59 | 0.67 | 0.69 | 0.83 | 0.75 |

### 5. Related Work

The goal of this challenge dataset is to develop methods to introspect a given MWP in order to identify how an LLM (in this case ChatGPT) will perform. Recent research in this area has examined MWPs can be solved by providing a step-by-step derivation. While these approaches provide insight into potential errors that can lead to incorrect results, this has not been studied in this prior work. Further, the methods of the aforementioned research are specific to the algorithmic approach. Work resulting from the use of our challenge dataset could lead to solutions that are agnostic to the underlying MWP solver—as we treat ChatGPT as a black box. We also note that, if such efforts to introspect MWPs are successful, it would likely complement a line of work dealing with “chain of thought reasoning” for LLMs which may inform better ways to generate MWP input into an LLM (e.g., an MWP with fewer additions may be decomposed into smaller problems). While some of this work also studied LLM performance on Math Word Problems (MWPs), it only looked at how various prompting techniques could improve performance rather than underlying characteristics of the MWP that leads to degraded performance of the LLM.

### 6. Future Work

Understanding the performance of commercial black-box LLMs will be an important topic as they will likely become widely used for both commercial and research purposes. Further future directions would also include an examination of ChatGPT performance on datasets other MWPs, investigating ChatGPT's nondeterminism, and exploring these studies on upcoming commercial LLM's to be released by companies such as Alphabet and Meta.

### SUMMARY

Examples of screening methodologies for a large language model system are disclosed. A study of the performance of a commercially available large language model (LLM) known as ChatGPT on math word problems (MWPs) from the dataset DRAW-1K. To our knowledge, this is the first independent evaluation of ChatGPT. We found that ChatGPT's performance changes dramatically based on the requirement to show its work, failing 20% of the time when it provides work compared with 84% when it does not. Further several factors about MWPs relating to the number of unknowns and number of operations that lead to a higher probability of failure when compared with the prior, specifically noting (across all experiments) that the probability of failure increases linearly with the number of addition and subtraction operations. We also have released the dataset of ChatGPT's responses to the MWPs to support further work on the characterization of LLM performance and present baseline machine learning models to predict if ChatGPT can correctly answer an MWP. We have released a dataset comprised of ChatGPT's responses to support further research in this area.

Referring to FIG. 6, a computing device 1200 is illustrated which may be configured, via the instructions 104 and/or other computer-executable instructions, to execute functionality described herein. More particularly, in some embodiments, aspects of the system and/or methods described herein may be translated to software or machine-level code, which may be installed to and/or executed by the computing device 1200 such that the computing device 1200 is configured to functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201 but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

Additional aspects of this disclosure are set out in the independent claims and preferred features are set out in the dependent claims. Features of one aspect may be applied to each aspect alone or in combination with other aspects. In addition, while certain operations in the claims are provided in a particular order, it is appreciated that such order is not required unless the context otherwise indicates.

What is claimed is:

1. A method for screening a large language model (LLM), comprising:
accessing a data input configured for a large language model associated with a user prompt;
conducting, by a processor, one or more prompt screening checks via the data input before applying the data input to the large language model, the one or more prompt screening checks configured to identify and block user prompts likely to produce undesirable output; and
conducting, by the processor, one or more output screening checks of the output of the data input as fed to the large language model to identify and block output from the large language model that produce the undesirable output.

2. The method of claim 1, wherein the one or more prompt screening checks include predetermined pre-processing functions configured to determine whether the data input should be blocked from application to the large language model.

3. The method of claim 2, wherein the one or more prompt screening checks include input restrictions that check whether certain predetermined keywords or phrases are present in the user prompt.

4. The method of claim 2, wherein the one or more prompt screening checks include input security checks that identify security information.

5. The method of claim 2, wherein the one or more prompt screening checks detect, from the user prompt, a pattern that is likely to produce the undesirable output.

6. The method of claim 1, wherein the undesirable output includes false, misleading, or offensive output from the large language model.

7. The method of claim 1, wherein the data input includes a textual math word problem.

8. The method of claim 1, wherein the one or more output screening checks includes a check of internal consistency of a response.

9. The method of claim 1, wherein the one or more output screening checks includes a check of consistency with known facts.

10. A system for large language model (LLM) screening, comprising:
a processor configured to execute one or more processes; and
a memory configured to store instructions executable by the processor such that the processor, when executing the instructions is operable to:
access a prompt associated with a user corresponding to an input intended for a large language model (LLM), and
preprocess the input before submission to the LLM via a prompt screening module configured to reduce false or erroneous output from the LLM in response to the input.

11. The system of claim 10, wherein the processor further:
processes the output before submission to the user via an output screening module to reduce likelihood of a false result being sent to the user.

12. The system of claim 10, wherein the LLM includes ChatGPT.
